(19) United States
(12) Patent Application Publication
(10) Pub. No.: US 2015/0364913 A1
(43) Pub. Date: Dec. 17, 2015

(54) LOAD DRIVING CIRCUIT

(71) Applicant: FUJI ELECTRIC CO., LTD., Kawasaki-shi (JP)

(72) Inventor: Yoshiaki MINOYA, Matsumoto-city (JP)

(21) Appl. No.: 14/708,601

(22) Filed: May 11, 2015

(30) Foreign Application Priority Data
Jun. 12, 2014 (JP) 2014-121328

(51) Int. Cl. H02H 9/02

(52) U.S. Cl. CPC H02H 9/025

(57) ABSTRACT

A short circuit detection circuit has an output voltage of a switching device inputted and, when the value of the output voltage becomes lower than a specified threshold value due to an abnormal state such as a load short circuit state, outputs a control signal to a clamping circuit for making the clamping circuit carry out such a clamping operation as to limit the output current of the switching device. When the output voltage rises again by the turning-on operation of the switching device, the change in the output voltage is transmitted onto the output side through a capacitor with following rising in the control signal, by which the rising of the output signal is detected with little delay.

### BACKGROUND OF INVENTION

1. Field of the Invention

Embodiments of the invention relates to load driving circuits, and particularly to a load driving circuits having a function of detecting a load short circuit.

2. Related Art

In a load driving circuit with a so-called high-side configuration having a switching device provided between the positive electrode of a power supply and a load, when the load driving circuit particularly drives an inductive load such as a linear solenoid, an output current is controlled by duty factor control. In output current control performed by the duty factor control, when an object driven by a linear solenoid (a transmission of a vehicle, for example) is excessively loaded to cause a resulting switching operation of the linear solenoid to be carried out with a current up to a large current region, a short circuit failure sometimes occurs in the linear solenoid as the inductive load.

As circuits against such a short circuit, some load driving circuits are known each of which is operated so as to reduce the current flowing a switching element when such a short circuit occurs in a load (see Japanese Patent Application Publication Nos. JP-A-2005-27380 (also referred to herein as “JP-A-2005-27380”) (paragraphs [0060] to [0066] and FIG. 2) and JP-A-2005-312099 (also referred to herein as “JP-A-2005-312099”) (paragraphs [0088] to [0092] and FIG. 2), for example). In the current limiting section in the load driving circuit disclosed in JP-A-2005-27380 (paragraphs [0060] to [0066] and FIG. 2), when the source voltage of a switching device at the starting-up of the load driving circuit is less than the specified reference voltage and the gate-source voltage of the switching device is equal to or more than the threshold voltage, the circuit is decided to be in an abnormal state including a load short circuit. The decision suppresses an increase in the gate-source voltage of the switching device to prevent the switching device from being brought into an overcurrent state. In the load driving circuit disclosed in JP-A-2005-312099 (paragraphs [0088] to [0092] and FIG. 2), when a current limiting circuit detects at the starting-up of the load driving circuit that the drain-source voltage of a switching device is equal to or more than the specified value, a load short circuit detection circuit has detected the load short circuit before the current limiting circuit carries out a current limiting operation. Thus, a logical circuit for protection informed of the detection of the load short circuit is operated so as to immediately interrupt an input to the gate terminal of the switching device.

In the load driving circuit described in JP-A-2005-27380 (paragraphs [0060] to [0066] and FIG. 2), the current limiting operation is carried out by clamping the gate-source voltage of the switching element when a load short circuit occurs to bring the source voltage (output voltage) of the switching device to be lower than the reference voltage. A drop in an output voltage like the drop at a load short circuit, however, is a variation that occurs also in a normal switching operation that is not a load short circuit. Therefore, even in a turned-off period in a normal switching operation of the switching device, the source voltage (output voltage) thereof is pulled-down by the load to become lower than the reference voltage. This causes the presence of the action of the clamping operation by the current limiting section. The current limiting operation by the current limiting section comes to be released while the gate voltage of the switching device is being raised by the output of a charge-pumping circuit, which raises the gate voltage higher than the source voltage in the switching device operated on the high electric potential side, when the state of the switching element is shifted from such a turned-off state to a subsequent state of a turning-on operation. In such a load driving circuit, however, when the level of a load current at the normal switching operation is close to the overcurrent detection level at a load short circuit, some operating conditions (power supply voltages, temperatures etc.) cause the rising of the output voltage to slow down to make the output voltage come to be left hard to rise. As a result, there was a problem of causing such a continuous abnormality processing mode that the current limiting section incorrectly detects that there has been a load short circuit and outputs an oscillating waveform from the output terminal. The oscillating waveform is the waveform of a driving signal in a state in which an actual overcurrent is detected. In the state, the operation mode is switched to an operation mode of carrying out an on-off oscillation control with a duty ratio of short turning-on period for reducing a loss due to self-heating. The driving signal with the oscillating waveform also plays a role of an alarm signal informing an occurrence of abnormality as will be explained later.

For further lowering the peak value of the limited current at the occurrence of an actual load short circuit, it is necessary to further lower the impedance in the portion of the circuit for clamping the gate-source voltage of the switching device to further reduce the gate-source voltage. However, there was also such a problem that excessive reduction of the impedance in the portion of the circuit for clamping further inhibits the rising of an output voltage at the normal switching operation to cause problems such as waveform distortion and an increase in turning-on time.

Furthermore, the use of a comparator for comparing the source voltage (output voltage) of the switching element with a reference voltage caused a problem such that the large scale circuit of the comparator expands a chip size to result in an increase in cost.

In addition, in the load driving circuit described in JP-A-2005-312099 (paragraphs [0088] to [0092] and FIG. 2), abnormality in a load is detected by a load short circuit detection circuit before a large current starts to flow in the switching device so that the logical circuit for protection immediately initiates current limitation on the basis of the result of the detection. Also in the case, however, when the level of the load current at the normal switching operation is close to the overcurrent detection level, there is the possibility of making the rising of the output voltage slow down at the turning-on of the switching device to cause the load short circuit detection circuit to incorrectly detect the slowed down rising in the output voltage as a load short circuit. This resulted in a problem in that the logical circuit for protection continues the state in which such an abnormality processing mode as to output the oscillating waveform from the output terminal is not released with the state of incorrect detection of the load short circuit left uncorrected. Thus, various problems exist in the related art.

### SUMMARY OF THE INVENTION

Embodiments of the invention address these and other problems. Embodiments of the invention provide a load driving circuit which can detect the rising of the output voltage at the turning-on in a normal switching operation with little delay and is prevented from such a malfunction as to incorrectly detect a state with a delay in the detection of the rising of the output voltage in a normal switching operation as a load short circuit state and shift the operation mode into an oscillation mode with which an abnormal state can be detected.

In some embodiments, a load driving circuit is provided which drives a load with a switching device, provided between a power supply terminal connected to the positive electrode of a power supply and an output terminal connected to the load, made to carry out a switching operation. The load driving circuit is provided with a clamping circuit which can carry out a clamping operation of limiting an output current of the switching device and a short circuit detection circuit which is provided between the output terminal and the clamping circuit, detects a drop in the voltage at the output terminal occurring when the load is short-circuited and outputs a control signal to the clamping circuit which signal is a signal for making the clamping circuit carry out the clamping operation of limiting the output current of the switching device. Here, the short circuit detection circuit is characterized by providing a capacitor between the input side thereof and the output side thereof.

This enables the short circuit detection circuit to immediately transmit the rising of the voltage at the output terminal of the load driving circuit to the output side thereof through the capacitor. Thus, the control signal for releasing the clamping operation can be outputted to the clamping circuit with immediate rising to enable an immediate clamp releasing operation. Therefore, in a normal switching operation, the load driving circuit can be prevented from such a malfunction as to incorrectly detect a state with a delay in the detection of the rising of the output voltage in a normal switching operation as a load short circuit state and shift the operation mode into an oscillation mode informing an abnormal state.

In some embodiments, the load driving circuit with the configuration explained in the foregoing can detect the rising of the output voltage at the turning-on in a normal switching operation with little delay while keeping the current limiting function at a load short circuit. Thus, in some embodiments, the load driving circuit has the advantage of being prevented from such a malfunction as to incorrectly detect a state with a delay in the detection of the rising of the output voltage as a load short circuit state and shift the operation mode into an abnormality processing mode such as an oscillation mode informing an abnormal state.

### BRIEF DESCRIPTION OF THE DRAWINGS

FIG. 1 is a block diagram showing an example of the configuration of the load driving circuit according to an embodiment of the invention;

FIG. 2 is an operation time chart corresponding to the truth table in Table 1 showing operation modes of the load driving circuit;

FIG. 3A is a block diagram showing the configuration of the measuring circuit of the overcurrent detection characteristics of the load driving circuit;

FIG. 3B is a waveform diagram showing the operation waveform at the measurement of an overcurrent;

FIG. 3C is a waveform diagram showing the operation waveform at the measurement of a peak current;

FIG. 4 is a circuit diagram showing an example of a level shift driver with an example of a related short circuit detection circuit connected thereto;

FIG. 5 is a circuit diagram showing a short circuit detection circuit of the load driving circuit according to the embodiment of the invention; and

FIG. 6 is a diagram illustrating the operation waveform in the related short circuit detection circuit shown in FIG. 4 and the operation waveform in the short circuit detection circuit according to the embodiment of the invention shown in FIG. 5.

### DETAILED DESCRIPTION

In the following, an embodiment of the invention will be explained in detail with reference to attached drawings.

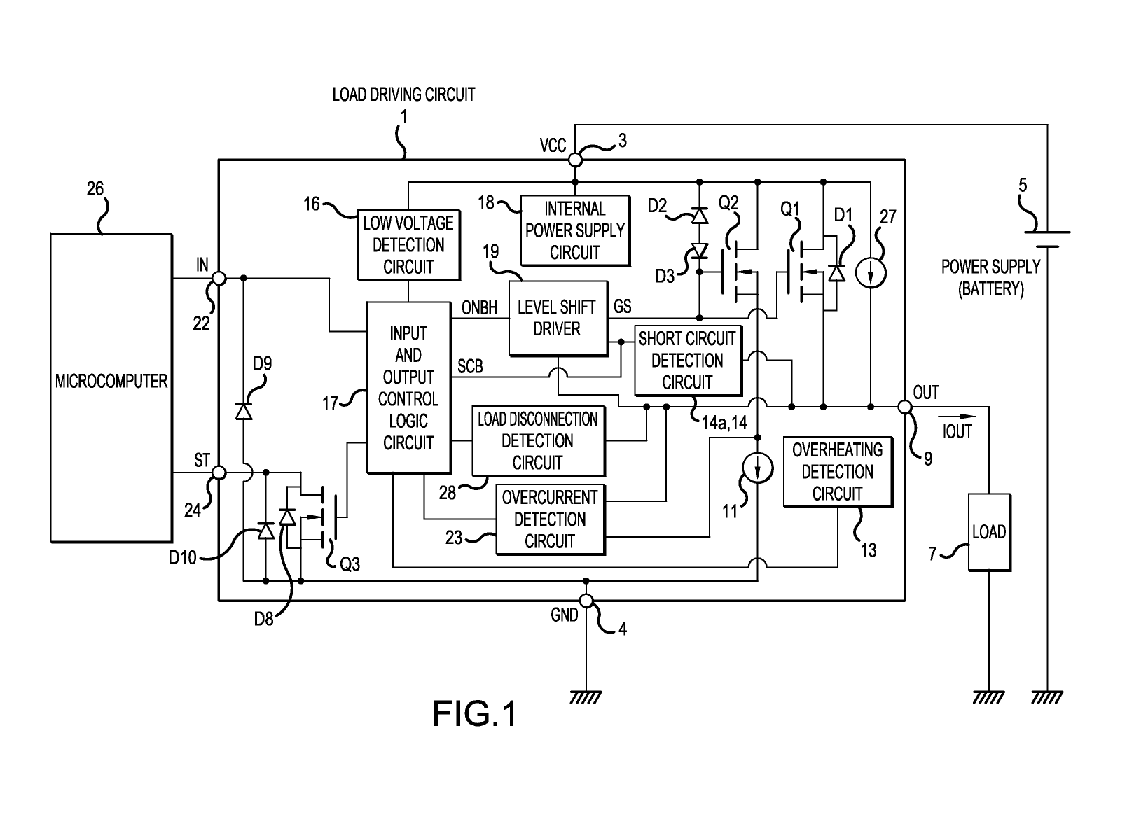

FIG. 1 is a block diagram showing an example of the configuration of a load driving circuit according to an embodiment of the invention.

The load driving circuit 1 has a VCC terminal 3 as a power supply terminal supplying a power supply voltage VCC, a GND terminal 4 as a grounding terminal, and an OUT terminal 9 as an output terminal. To the VCC terminal 3, the positive electrode of a power supply (battery) 5 is connected and to the OUT terminal 9, one end of a load 7 is connected. All of the negative electrode of the power supply 5, the other end of the load 7 and the GND terminal 4 are grounded.

In the load driving circuit 1, between the VCC terminal 3 and the OUT terminal 9, a switching device Q1 of an n-channel MOSFET (Metal-Oxide-Semiconductor Field-Effect Transistor) is provided. A diode D1 connected in inverse-parallel to the switching device Q1 between the drain terminal and the source terminal thereof is a parasitic diode. In this way, the load driving circuit 1 according to the embodiment is an intelligent power switch of a so-called high-side configuration with the switching device Q1 provided between the positive electrode of the power supply 5 and the load 7. Moreover, between the VCC terminal 3 and the GND terminal 4, a switching device Q2 of an n-channel MOSFET and a constant current device 11 are connected in series. Between the drain terminal and the gate terminal of the switching device Q1 and between the drain terminal and the gate terminal of the switching device Q2, two diodes D2 and D3 connected in inverse-series to each other are provided for protecting the gates of the switching devices Q1 and Q2.

The load driving circuit 1 has an overheating detection circuit 13 detecting the overheating of the switching device Q1. The overheating detection circuit 13 is formed so as to transmit the result of detection to an input and output control logical circuit 17. The overheating detection circuit 13 can be provided as a diode, which is formed so as to detect an overheating state by making use of the temperature dependence in the forward voltage of the diode.

The load driving circuit 1 has a short circuit detection circuit 14 detecting the short circuit of the load 7. The input side of the short circuit detection circuit 14 is connected to the OUT terminal 9 and the output side thereof is connected to the input and output control logical circuit 17 and a level shift driver 19. The short circuit detection circuit 14 is a circuit that detects a drop in the voltage VOUT at the OUT terminal 9 occurring at a short circuit in the load 7 and transmits the detected result to the input and output control logical circuit 17 and the level shift driver 19. The details of the configuration and the working of the short circuit detection circuit 14 will be explained later.

The load driving circuit 1 has a low voltage detection circuit 16. The low voltage detection circuit 16, with the input side thereof connected to the VCC terminal 3 and the output side thereof connected to the input and output control logical circuit 17, has a function of detecting that the power supply voltage VCC supplied from the power supply 5 is lowered and transmitting the detected result to the input and output control logical circuit 17.

The level shift driver 19 has the input side thereof connected to the input and output control logical circuit 17 and has the output side thereof connected to the gate terminals of the switching devices Q1 and Q2. To the input and output control logical circuit 17, an on-off signal for an on- and off-driving of the switching devices Q1 and Q2 is inputted from the outside (in the embodiment, a microcomputer 26) through an IN terminal 22 as an input terminal. In response to the on-off signal, the input and output control logical circuit 17 outputs an on-off signal ONBH to the level shift driver 19. The level shift driver 19 carries out the level shift of the on-off signal ONBH and outputs a level-shifted on-off signal (an output signal GS) to the gate terminals of the switching devices Q1 and Q2.

The load driving circuit 1 has an overcurrent detection circuit 23. The input side of the overcurrent detection circuit 23 is connected to the OUT terminal 9 to which the source terminal of the switching device Q1 is connected and to the connection point of the source terminal of the switching device Q2 and the constant current device 11. The output side of the overcurrent detection circuit 23 is connected to the input and output control logical circuit 17. The overcurrent detection circuit 23 contains a comparator comparing the voltage of the OUT terminal 9 and the voltage at the connection point of the switching device Q2 and the constant current device 11 to carry out comparison of the source voltages of the switching devices Q1 and Q2 when both of them are turned-on. The comparator, with the gate voltages of the switching devices Q1 and Q2 being common thereto, indirectly compares currents flowing in the switching devices Q1 and Q2 by comparing the respective gate-source voltages of both. The comparator, when the source voltage of the switching device Q1 (the voltage VOUT at the OUT terminal 9) is lower than the source voltage of the switching device Q2, that is, when the gate-source voltage of the switching device Q1 is higher than the gate-source voltage of the switching device Q2, makes a decision that an overcurrent flows in the switching device Q1. The result of the decision of the comparator is transmitted to the input and output control logical circuit 17.

The load driving circuit 1 has a load disconnection detection circuit 28 and a constant current device 27. The load disconnection detection circuit 28 has the input side thereof connected to the OUT terminal 9 and has the output side thereof connected to the input and output control logical circuit 17. The constant current device 27 is connected between the VCC terminal 3 and the OUT terminal 9. The load disconnection detection circuit 28 detects a state of load disconnection by detecting a voltage (the voltage VOUT at the OUT terminal 9) produced by a current flowing in the load disconnection detection circuit 28 through the constant current device 27 during the turning-off period of the switching operation. Namely, the load disconnection detection circuit 28 makes a decision that the load 7 is in a disconnected state when the voltage VOUT at the OUT terminal 9 becomes high with the load 7 being electrically disconnected due to a broken wire or with the resistance of the section between the OUT terminal 9 and the load 7 becoming high rather than becoming infinite. The result of the decision by the load disconnection detection circuit 28 is transmitted to the input and output control logical circuit 17.

The load driving circuit 1 has an ST terminal 24 as a status output terminal. Between the ST terminal 24 and the input and output control logical circuit 17, a switching device Q3 of an n-channel MOSFET is provided. The gate terminal of the switching device Q3 is connected to the input and output control logical circuit 17 at a terminal outputting a status decision signal. The drain terminal of the switching device Q3 is connected to the ST terminal 24 and the source terminal thereof is grounded. A diode D8 connected to the drain terminal and the source terminal of the switching device Q3 in inverse parallel thereto is a parasitic diode. In addition, a diode D9, connected between the IN terminal 22 and the GND terminal 4, is provided for protecting the input and output control logical circuit 17 and a diode D10 is provided for protecting the switching device Q3. To the IN terminal 22 and the ST terminal 24, a microcomputer 26 is connected.

The load driving circuit 1 further has an internal power supply circuit 18 connected to the VCC terminal 3 for producing specified voltages (voltages of 5V, VCC-5V etc., for example) by using the power supply voltage VCC supplied from the power supply 5. The internal power supply circuit 18 supplies the produced voltages to the overheating detection circuit 13, the short circuit detection circuit 14, the low voltage detection circuit 16, the overcurrent detection circuit 23, the load disconnection detection circuit 28, the input and output control logical circuit 17 and the level shift driver 19 as high potential side voltages or low potential side voltages of the power supply. The supplied voltages are used for bringing the amplitudes of signals outputted from the foregoing circuits to the level of 5V, for example.

Next to this, the operation of the load driving circuit 1 according to the embodiment of the invention will be explained with reference to the following Table 1 and Table 2.

TABLE 1

| MODE | IN | ST | OUT | NOTE |
|---|---|---|---|---|
| NORMAL | L | L | L | HYSTERESIS |
| OPERATION | H | H | H | |
| OVERHEATING | L | L | L | SELF-RESET |
| DETECTION | H | L | L | HYSTERESIS |
| OVERCURRENT | L | L | L | SELF-RESET |
| DETECTION | H | L | L | OSCILLATION MODE |
| | | | | IN OUT |
| | | | | NO HYSTERESIS |
| LOAD | L | H | H | SELF-RESET |
| DISCONNECTION | | | | HYSTERESIS |
| DETECTION | | | | |
| IN TERMINAL | Open | L | L | Open = Low IS MEANT BY |
| OPEN | | | | PULLING-DOWN |
| | | | | FUNCTION OF INPUT |
| | | | | TERMINAL |

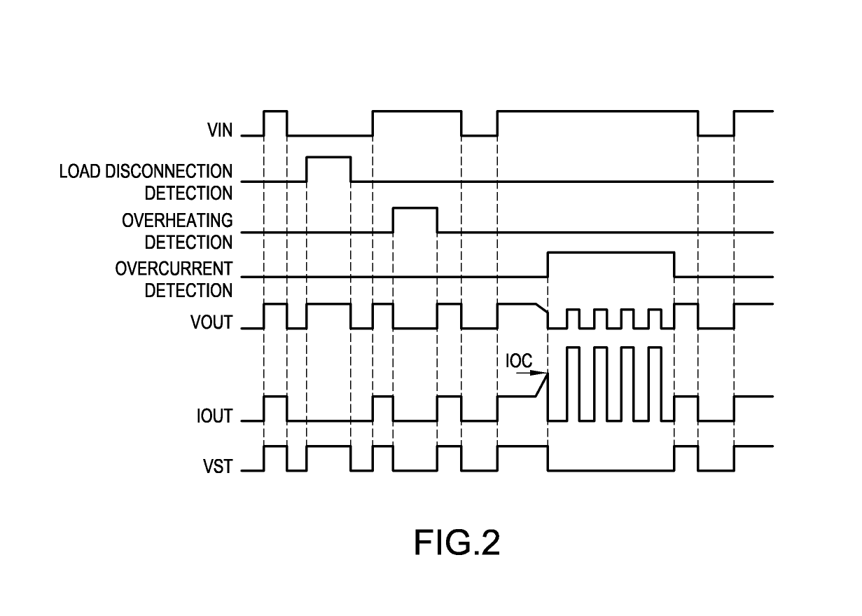

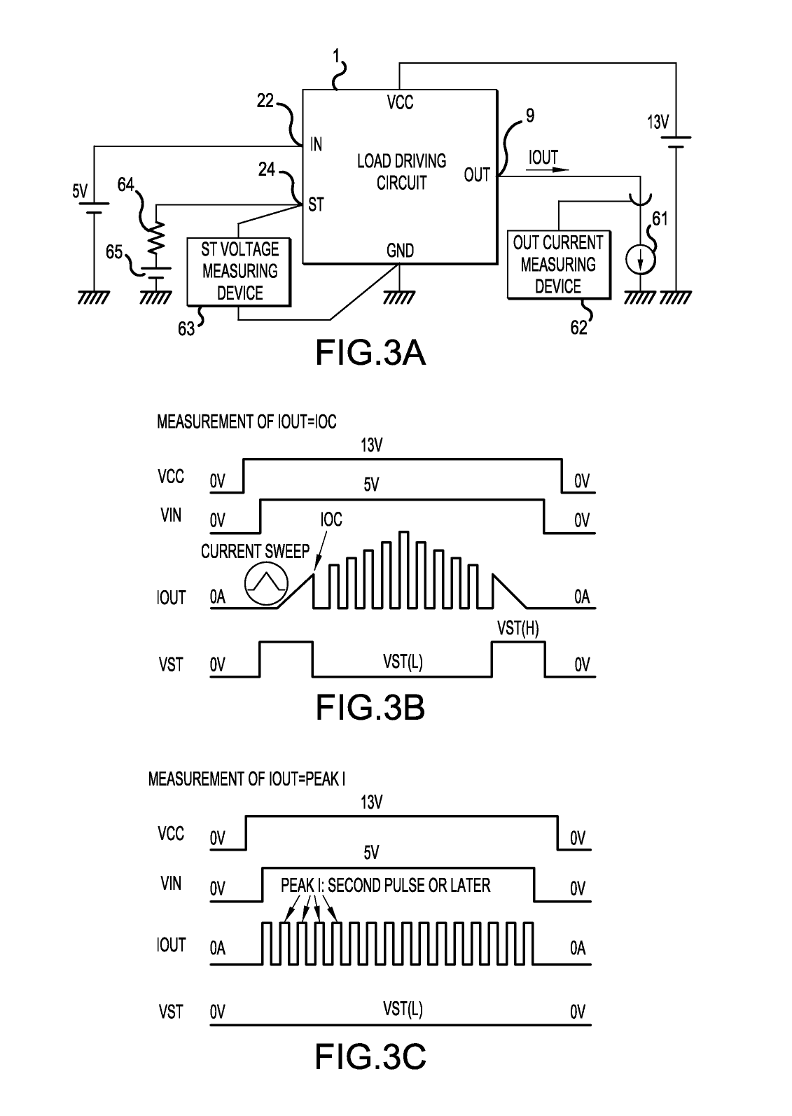

Table 1 is a truth table showing operation modes of the load driving circuit 1 and Table 2 shows excerpts of items of information with respect to the overcurrent detection current IOC, the peak current PeakI under the overcurrent detection mode etc. from the specification prescribing characteristic items of the load driving circuit 1. In addition, an operation time chart corresponding to Table 1 is shown in FIG. 2 and a measuring circuit for measuring the items of overcurrent detection characteristics in Table 2 and operation waveforms measured by the measuring circuit are shown in FIGS. 3A to 3C, respectively.

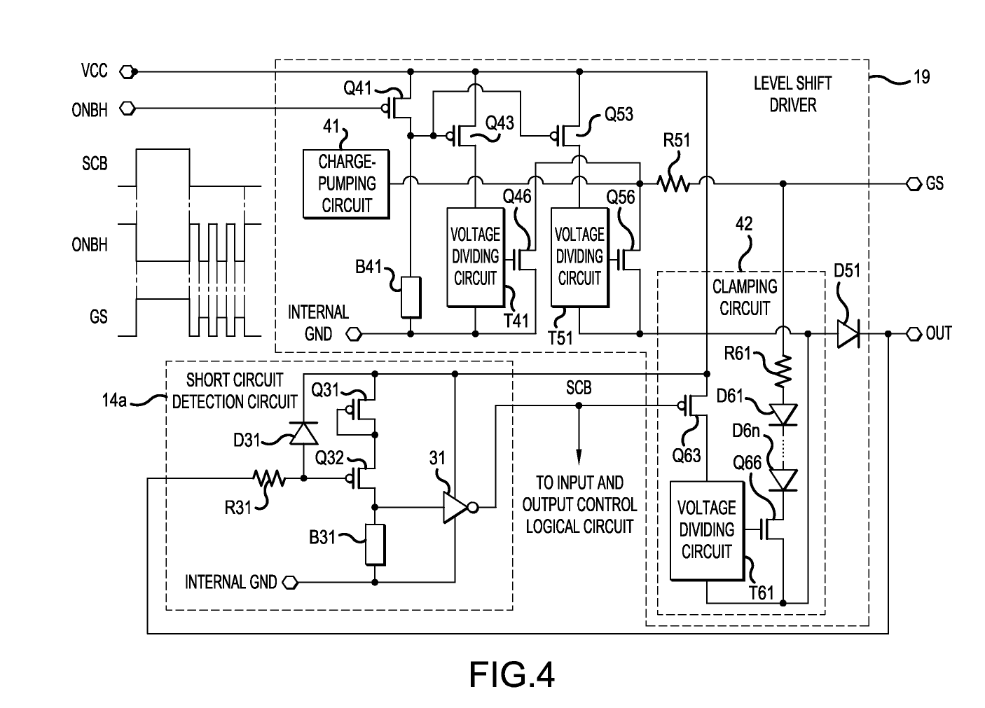

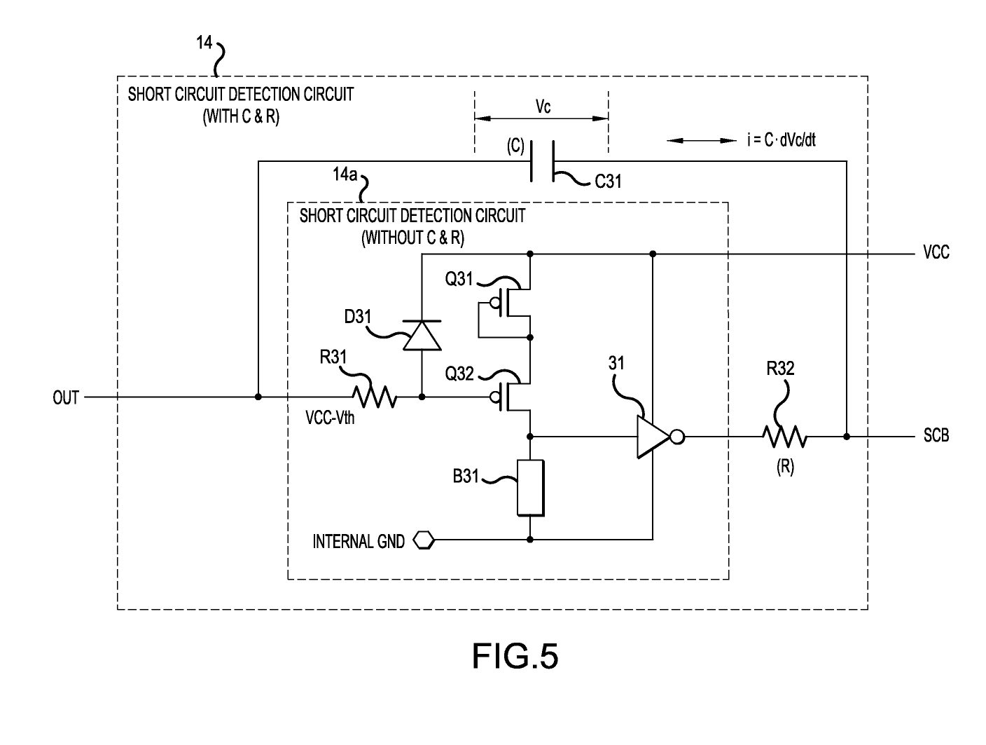

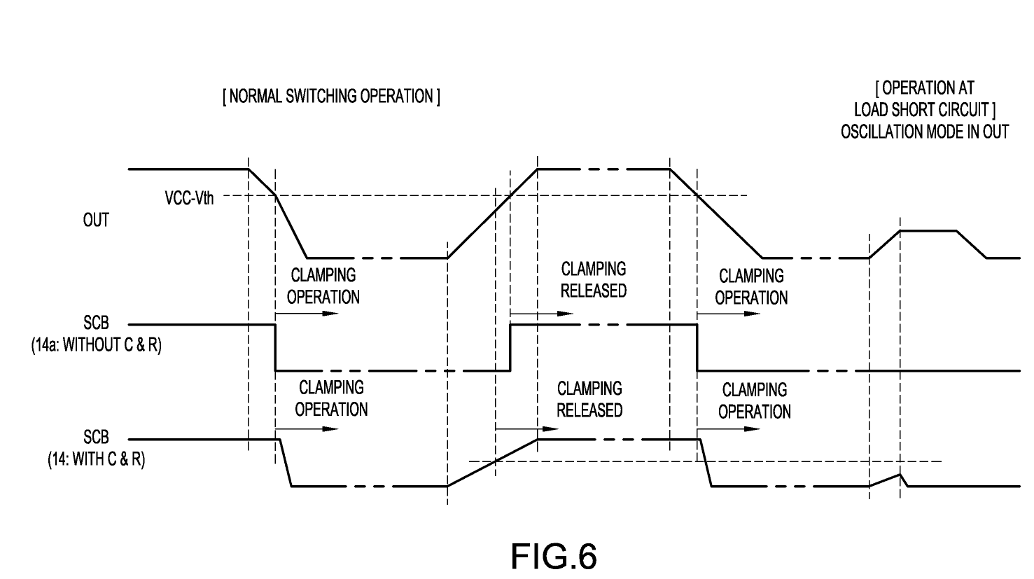

FIG. 2 is an operation time chart corresponding to the truth table in Table 1 showing operation modes of the load driving circuit 1. FIGS. 3A to 3C are diagrams showing the measurement of the overcurrent detection characteristics of the load driving circuit 1. FIG. 3A is a block diagram showing the configuration of the measuring circuit of the overcurrent detection characteristics of the load driving circuit 1. FIG. 3B is a waveform diagram showing the operation waveform at the measurement of an overcurrent. FIG. 3C is a waveform diagram showing the operation waveform at the measurement of a peak current. FIG. 4 is a circuit diagram showing the level shift driver 19 with a related short circuit detection circuit 14a connected thereto. FIG. 5 is a circuit diagram showing the short circuit detection circuit 14 of the load driving circuit 1 according to the embodiment of the invention. FIG. 6 is a diagram illustrating the operation waveform in the related short circuit detection circuit 14a shown in FIG. 4 and the operation waveform in the short circuit detection circuit 14 according to the embodiment of the invention shown in FIG. 5.

First, when the load driving circuit 1 is under a normal state (a normal operation mode in Table 1) and the voltage VIN at the IN terminal 22 is at an L (Low) level, the input and output control logical circuit 17, having the voltage VIN at the L level inputted, outputs an H (High) level signal to the gate terminal of the switching device Q3 to turn-on the switching device Q3 to thereby bring the ST terminal 24 to the L level. At this time, the input and output control logical circuit 17 outputs an on-off signal ONBH at the H level to the level shift driver 19. The level shift driver 19, having the on-off signal ONBH at the H level inputted, outputs the output signal GS at the L level instructing turning-off to the gates of the switching devices Q1 and Q2. This makes the switching devices Q1 and Q2 turned-off. As a result, the voltage at the OUT terminal 9 is brought to the L level through the load 7. In other words, the load 7, normally having a low resistance value of the order of 10 Ω, pulls-down the voltage at the OUT terminal 9. In short, when the voltage at the IN terminal 22 is at the L level (hereinafter “the voltage at the xx terminal” will be also referred to simply as “the xx terminal”), that is, when the voltage VIN in FIG. 2 is at the L level, each of the voltage VOUT and a current IOUT at the OUT terminal 9 and a voltage VST at the ST terminal 24 comes to be at the L level.

While, when the level of the voltage at the IN terminal 22 becomes the H (High) level under the normal state, the input and output control logical circuit 17 outputs the L level signal to the gate terminal of the switching device Q3 to turn-off the switching device Q3 to thereby bring the level of the voltage at the ST terminal 24 to the H level (the voltage inside the microcomputer 26 pulls-up the voltage at the ST terminal 24). At this time, as will be explained later in detail, the input and output control logical circuit 17 also outputs the on-off signal ONBH at the L level to the level shift driver 19, by which the level shift driver 19 outputs the output signal GS at the H level instructing turning-on to the gate terminals of the switching devices Q1 and Q2. Then, the switching devices Q1 and Q2 are made turned-on to result in the H level voltage at the OUT terminal 9, by which a current flows in the load 7. Namely, in FIG. 2, when the level of the voltage VIN at the IN terminal 22 is at the H level, the level of each of the voltage VOUT and a current IOUT at the OUT terminal 9 and the voltage VST at the ST terminal 24 becomes the H level.

However, in an IN terminal disconnection (Open) state in which no connection is provided between the IN terminal 22 and the microcomputer 26 (IN terminal disconnection mode in Table 1), a pull-down function built in the input and output control logical circuit 17 brings the state of the input and output control logical circuit 17 to be equivalent to the state when a voltage at the L level is inputted to the IN terminal 22. This brings the levels of the voltages at both of the OUT terminal 9 and the ST terminal 24 to the L level, which is the same state as a state when a voltage at the L level is inputted to the IN terminal 22.

In the next, the detection of load disconnection will be explained. The detection of load disconnection is, as is shown with respect to the load disconnection detection mode in Table 1, carried out with the IN terminal 22 being at the L level. Namely, like in the case in which the IN terminal 22 is at the L level in the normal state, the detection of load disconnection is carried out when the output signal GS outputted from the level shift driver 19 comes to be at the L level to make the switching device Q1 turned-off. Here, the state of the load disconnection is to include not only the state in which the connecting section between the OUT terminal 9 and the load 7 is made completely opened but also the state in which the resistance in the connecting section becomes high rather than infinite.

In such a state that the load 7 is disconnected, the current from the constant current device 27 does not flow onto the load 7 side but flows into the load disconnection detection circuit 28 as was explained in the foregoing. In addition, the current charges a parasitic capacitor on the OUT terminal 9 and becomes a component of the leak current of internal circuits. This, as is shown in FIG. 2, brings the level of the voltage VOUT at the OUT terminal 9 to the H level which voltage is an input voltage to the load disconnection detection circuit 28. The load disconnection detection circuit 28 detecting the H level voltage VOUT outputs an H level detection signal to the input and output control logical circuit 17. The input and output control logical circuit 17, having the H level detection signal inputted, outputs an L level signal to the gate terminal of the switching device Q3 to turn-off the switching device Q3, by which the level of the voltage VST at the ST terminal 24 is made to be at the H level. At this time, the microcomputer 26, on the basis of an abnormal state in which the voltage at the ST terminal 24 is at the H level when the voltage at the IN terminal 22 is at the L level, makes a decision of the detection of load disconnection.

Subsequent to this, overcurrent detection will be explained. The overcurrent detection is, as is shown with respect to the overcurrent detection mode in Table 1, carried out with the IN terminal 22 being at the H level. Namely, the overcurrent detection is carried out when the output signal GS outputted from the level shift driver 19 comes to be at the H level to make the switching devices Q1 and 02 turned-off. The current flowing in the load 7 is equal to the current flowing in the switching device Q1 shown in FIG. 1. The load driving circuit 1 is normally designed so that the n-channel MOSFET forming the switching device Q1 is operated in the saturation region thereof. Thus, a current flowing in the saturation region is almost determined by a gate-source voltage and the value of the current becomes a monotone increasing function to the gate-source voltage. When each of the load 7 and the switching device Q1 is brought into the state with an overcurrent flowing therein, the gate-source voltage of the MOSFET forming the switching device Q1 comes to have a large value. While, the gate-source voltage of the n-channel MOSFET forming the switching device Q2 comes to have a constant value determined by the value of the constant current of the constant current device 11. Since the gate voltages of the switching devices Q1 and Q2 are equal to each other, the gate-source voltage voltages of both of them can be compared by the source voltages of both of them.

The overcurrent detection circuit 23 is provided with a comparator with differential inputs with which comparator the source voltage of the switching device Q1 and the source voltages of the switching device Q2 are compared and the difference between them is amplified. When the source voltage of the switching device Q1 is lower than the source voltage of the switching device Q2 with an overcurrent flowing in the switching device Q1, an overcurrent detection signal (a logical signal at the H level in FIG. 2) is outputted. That is, when the gate-source voltage of the switching device Q1 is larger than that of the source voltage of the switching device Q2, the overcurrent detection circuit 23 outputs the overcurrent detection signal to the input and output control logical circuit 17. Namely, with the size ratio “n” of the switching device Q1 to the switching device Q2 expressed as n=[size of switching device Q1]/[size of switching device Q2], and with the value of the constant current flowing the constant current device 11 expressed as lo, the current flowing in the switching device Q1 at this time is to be larger than nlo (=overcurrent detection current IOC), which the overcurrent detection circuit 23 decides as an overcurrent state (IOUT≧IOC) and the overcurrent detection signal is outputted to the input and output control logical circuit 17.

The overcurrent detection signal outputted from the overcurrent detection circuit 23 to the input and output control logical circuit 17 makes the input and output control logical circuit 17 output an H level signal to the gate terminal of the switching device Q3 on the basis of the overcurrent detection signal to turn-on the switching device Q3, which brings the level of the output signal of the ST terminal 24 to the L level. In addition, the input and output control logical circuit 17 outputs the on-off signal ONBH at the H level to the level shift driver 19 on the basis of the overcurrent detection signal at the H level outputted from the overcurrent detection circuit 23 to thereby make the level shift driver 19 output the output signal GS at the L level. The output signal GS at the L level is inputted to the gate terminals of the switching devices Q1 and Q2 to turn-off the switching devices Q1 and Q2, which brings the level of the OUT terminal 9 to the L level.

The voltage at the OUT terminal 9 with the level thereof brought to the L level is detected by the short circuit detection circuit 14, which outputs a signal SCB at the L level to the input and output control logical circuit 17 and the level shift driver 19. With the signal SCB at the L level and the overcurrent detection signal outputted from the overcurrent detection circuit 23, the input and output control logical circuit 17 changes the on-off signal ONBH to a signal with a pulse shaped oscillating waveform with the frequency thereof far higher than the switching frequency of the output voltage driving the load in a normal operation and outputs the changed on-off signal ONBH to the level shift driver 19. The level shift driver 19, having the on-off signal ONBH with the oscillating waveform and the signal SCB at the L level inputted, outputs the output signal GS, having the oscillating waveform with the peak value thereof clamped, to drive the switching devices Q1 and Q2 by the output signal GS with a loss due to an overcurrent being decreased. As a result, a voltage with an oscillating waveform is outputted from the OUT terminal with the peak value which depends on impedance of the load 7 and current from the switching device Q1.

Also in the case in which the overheating detection circuit 13 has detected the overheating of the switching device Q1, the input and output control logical circuit 17, on the basis of an overheating detection signal outputted from the overheating detection circuit 13, outputs the signal at the H level to the gate terminal of the switching device Q3 to turn-on the switching device Q3 to thereby bring the level of the voltage at the ST terminal to be at the L level. In addition, the input and output control logical circuit 17 outputs the on-off signal ONBH at the H level to the level shift driver 19 on the basis of the overheating detection signal outputted from the overheating detection circuit 13 to thereby make the level shift driver 19 output the output signal GS at the L level. The output signal GS at the L level is inputted to the gate terminals of the switching devices Q1 and Q2 to turn-off the switching devices 01 and Q2, which brings the level of the voltage at the OUT terminal 9 to be at the L level. At this time, the microcomputer 26, on the basis of an abnormal state in which each of the voltages at the ST terminal 24 and the OUT terminal 9 is at the L level when the voltage at the IN terminal 22 is at the H level, makes a decision of the overheating detection.

The overcurrent detection characteristics in the load driving circuit 1 are measured by a measuring circuit shown in FIG. 3A. Namely, to the OUT terminal 9 of the load driving circuit 1, a current source 61 is connected as a measuring device for determining the envelope when varying the output current IOUT of the load driving circuit 1 and the value of the actual output current IOUT is measured by an OUT current measuring device 62 through a current transformer or a shunt resistor, for example. The voltage VST at the ST terminal 24 is measured by an ST voltage measuring device 63 connected to the ST terminal 24. Here, a resistor 64 and a voltage source 65 are for simulating the pull-up function built in the microcomputer 26 connected to the load driving circuit 1 in the actual operation.

When a measurement is carried out with respect to the overcurrent detection current IOC in the normal switching operation of the load driving circuit 1, as is shown in FIG. 3B, the current source 61 is set so as to let an output current IOUT flow with the value thereof swept in a mountain shape in a period in which the voltage VIN at the IN terminal 22 is at the H level. This makes the output current IOUT exhibit pulse shaped oscillating waveforms during a period from the time at which the value of the output current IOUT becomes larger than the value of the overcurrent detection current IOC to bring the level of the voltage VST at the ST terminal 24 to be at the L level to the time at which the value of the output current IOUT becomes smaller than the value of the overcurrent detection current IOC to bring the level of the voltage VST at the ST terminal 24 to be at the H level again, in which the peak values of the respective pulses correspond to the value of the envelope of the swept output current IOUT. Here, the value of the output current IOUT at the instant of initiating oscillation with the level of the voltage VST brought to the L level from the H level becomes the measured value of the overcurrent detection current IOC.

Moreover, when a measurement is carried out with respect to a peak current under overcurrent detection mode Peakl at the short circuit detection in the load driving circuit 1, the OUT terminal 9 is brought into a state the same as the state at a load short circuit (grounded by low impedance wiring). This, as is shown in FIG. 3C, makes the output current IOUT exhibit an oscillating waveform during the period in which the voltage VIN at the IN terminal 22 is at the H level and each of the peak values of the pulses after the second pulse of the pulses in the oscillating waveform is measured as a peak current PeakI.

In addition, although not shown in FIG. 1 and FIG. 2, when the low voltage detection circuit 16 detects a low voltage, the input and output control logical circuit 17 resets the internal logic state so that no internal logic state becomes undefined and brings the switching devices Q1, Q2 and Q3 into turned-off states. Therefore, regardless of whether the level of the IN terminal 22 is at the H level or at the L level, the levels of the OUT terminal 9 and the ST terminal 24 become the L level.

Thus, the microcomputer 26, on the basis of the abnormality that the level of the ST terminal 24 becomes the L level when the IN terminal 22 is at the H level, makes the decision of overcurrent, overheating or lowered voltage.

Here, “SELF-RESET” written in Table 1 means that when the state of the load driving circuit 1 becomes normal with the cause of the detected abnormality removed, the operation of the load driving circuit 1 is automatically reset to the normal operation without any special electrical resetting operation. Moreover, the “OUT OUTPUT OSCILLATION MODE” written in Table 1 means the oscillating operations of the voltage VOUT and the output current IOUT at the OUT terminal 9 observed in the period of “OVERCURRENT DETECTION” shown in FIG. 2. In the oscillating operation, the operation is repeated in which the switching device Q1 is turned-on and then turned-off when the value of the current flowing therein reaches a specified value. As a result, the load driving circuit 1 is kept in a stand-by state with the current flowing in the load 7 made to have an oscillating waveform so as to reduce a loss during the period from the overcurrent detection to the restoration to the normal operation. The oscillating waveform also becomes an alarm signal externally informing that the load driving circuit 1 is in the overcurrent state.

Here, the “OVER CURRENT DETECTION MODE” written in Table 2 is the “OUT OUTPUT OSCILLATION MODE”. The measurement of the peak current Peakl is carried out when the output current IOUT is made oscillated with the measuring circuit brought into the state of measuring the peak current Peakl of the output current IOUT shown as “MEASUREMENT OF IOUT=PeakI” in FIG. 3C, namely with the OUT terminal 9 made to be in the state similar to that in the load short circuit (grounded with low impedance wiring). The measurements of the period “Per” and the duty “Duty” of the oscillating output current IOUT are also carried out in the same way when the output current IOUT is made oscillated with the OUT terminal 9 made to be in the state similar to that in the load short circuit. Here, the period “Per” is a duration from the rising of the oscillating waveform of the output current IOUT to the next rising of the oscillating waveform thereof and the duty “Duty” is the proportion of the turned-on duration of the output current IOUT occupying in the period “Per” of the oscillating waveform thereof.

In order to reduce the level of the peak current Peakl to a desired value, it is necessary to reduce the value of the gate-source voltage of the switching device Q1 to the value required for the reduction. A clamping circuit 42 in the inner circuit of the level shift driver 19 shown in FIG. 4 has the function.

The level shift driver 19 has a p-channel MOSFET Q41 with the source terminal thereof connected to the power supply that supplies the power supply voltage VCC, the gate terminal thereof receiving the on-off signal ONBH from the input and output control logical circuit 17 and the drain terminal thereof connected to an internal GND through a bias circuit B41. The bias circuit B41 is a circuit that supplies a bias voltage for pulling-down the gate voltage of each of the p-channel MOSFETs Q43 and Q53 to a voltage at the L level when the p-channel MOSFET Q41 is turned off. The connection point of the drain terminal of the p-channel MOSFET Q41 and the bias circuit B41 is connected to the gate terminals of p-channel MOSFETs Q43 and Q53. The p-channel MOSFETs Q43 and Q53 are connected to the power supply, which supplies the power supply voltage VCC, with the source terminals thereof and are connected to the one end of a voltage dividing circuit T41 and the one end of a voltage dividing circuit T51 with their respective drain terminals. The voltage dividing circuit T41 is connected to the internal GND with the other end thereof and is connected to the gate terminal of an n-channel MOSFET Q46 with the divided voltage outputting terminal thereof. The n-channel MOSFET Q46 is connected to the internal GND with the source terminal thereof and is connected to the output side of a charge-pumping circuit 41, which supplies a voltage higher than the power supply voltage VCC, with the drain terminal thereof. The voltage dividing circuit T51 is connected to the gate terminal of an n-channel MOSFET Q56 with the divided voltage outputting terminal thereof. The other end of the voltage dividing circuit T51 and the source terminal of the n-channel MOSFET Q56 are connected together to be further connected to the anode terminal of a diode D51. The n-channel MOSFET Q56 is connected to the output side of the charge-pumping circuit 41 with the drain terminal thereof. The charge-pumping circuit 41 is formed so as to output the output signal GS to the gate terminals of the switching devices Q1 and Q2 shown in FIG. 1 through a resistor R51. The diode D51 is connected to the OUT terminal 9 shown in FIG. 1 with the cathode terminal thereof.

Between the output terminal of the output signal GS and the anode terminal of the diode D 51, the clamping circuit 42 explained before is arranged. The clamping circuit 42 has a resistor R61 with the one end thereof connected to the output terminal of the output signal GS. The other end of the resistor R61 is connected to the anode terminal of a diode D61 at one end of the series connection of a plurality of diodes D61 to D6n (n is an arbitrary number) arranged in the same direction. The cathode terminal of the diode D6n is connected to the drain terminal of an n-channel MOSFET Q66 and the source terminal of the n-channel MOSFET Q66 is connected to the anode terminal of the diode D51.

The clamping circuit 42 further has a p-channel MOSFET Q63 and a voltage dividing circuit T61. The p-channel MOSFET Q63 has a source terminal connected to the power supply that supplies the power supply voltage VCC and has a drain terminal connected to one end of the voltage dividing circuit T61 and has a gate terminal connected to the output side of a short circuit detection circuit (here, a related short circuit detection circuit 14a). The other end of the voltage dividing circuit T61 is connected to the source terminal of the n-channel MOSFET Q66 and the divided voltage outputting terminal of the voltage dividing circuit T61 is connected to the gate terminal of the n-channel MOSFET Q66.

The short circuit detection circuit 14a with a related configuration shown in FIG. 4 is that for being compared with the advantage of the short circuit detection circuit 14 according to the invention in the load driving circuit 1 that will be explained later. The related short circuit detection circuit 14a has a resistor R31 with one end thereof connected to the OUT terminal 9 of the load driving circuit 1. The other end of the resistor R31 is connected to the anode terminal of a diode D31 and the gate terminal of a p-channel MOSFET Q32. The cathode terminal of the diode D31 is connected to the power supply that supplies the power supply voltage VCC. The power supply voltage VCC is also supplied to the source terminal of a p-channel MOSFET Q31 the gate terminal and the drain terminal of which are connected to the source terminal of the p-channel MOSFET Q32. The drain terminal of the p-channel MOSFET Q32 is connected to one end of a bias circuit B31, the other end of which is connected to the internal GND. The connection point of the drain terminal of the p-channel MOSFET Q32 and the one end of the bias circuit B31 is connected to the input side of an inverter circuit 31, which supplies the signal SCB to the input and output control logical circuit 17 and the clamping circuit 42 in the level shift driver 19.

Here, inside the level shift driver 19, at an on-driving timing at which the level of the on-off signal ONBH becomes the L level, the p-channel MOSFET Q41 is turned-on, by which the level of the voltage of each of the gate terminals of the p-channel MOSFETs Q43 and Q53 in the next stage becomes the H level to turn-off both of the p-channel MOSFETs Q43 and Q53. This causes the levels of the divided voltages outputted from the voltage dividing circuits T41 and T51 connected to the drain terminals of the p-channel MOSFETs Q43 and Q53, respectively, to be at their L levels, by which both of the n-channel MOSFETs Q46 and Q56, each having the divided voltage at the L level inputted to its own gate terminal, are made to be turned-off. Therefore, a voltage with the level thereof stepped up by the charge-pumping circuit 41 to be higher than the power supply voltage VCC is outputted from the level shift driver 19 through the resistor R51 as the output signal GS at the H level without being pulled down by the n-channel MOSFETs Q46 and Q56. The stepped up output signal GS is inputted to the gate terminals of the switching devices Q1 and Q2 to drive the switching devices Q1 and Q2 so as to be turned-on.

In on-driving, when the short circuit detection circuit 14a detects the drop in the voltage VOUT at the OUT terminal 9 to thereby detect a load short circuit, the short circuit detection circuit 14a outputs the signal SCB at the L level. Namely, in the short circuit detection circuit 14a, the drop in the voltage VOUT causes the p-channel MOSFET Q32 to turn-on to bring the level of the voltage at the connection point of the drain terminal of the p-channel MOSFET Q32, the bias circuit B31 and the inverter circuit 31, i.e. the level of the voltage inputted to the inverter circuit 31, to the H level, by which the level of the signal SCB outputted from the inverter circuit 31 becomes the L level. This turns-on the p-channel MOSFET Q63 in the clamping circuit 42 to raise the divided output voltage of the voltage dividing circuit T61, which is to raise the gate voltage of the n-channel MOSFET Q66 and is to turn on the n-channel MOSFET Q66. As a result, the voltage between the output terminal of the charge-pumping circuit 41 and the OUT terminal 9 is divided into the voltage determined by the resistance of the resistor R51 and the impedance determined by the resistor R61, the diodes D61 to D6n and D51 to clamp the voltage of the output signal GS. By the value of the voltage of clamping the output signal GS, the level of the desired peak current Peakl is determined. Therefore, the resistance value of the resistor R61 and the number n of the diodes D61 to D6n normally become the important factors in the adjustment for determining the level of the peak current PeakI. Here, the resistor R51 is an element relating to the switching time and the diode D51 is an element for protecting the circuit, so that they are out of the important factors in the adjustment.

Next, at an off-driving timing at which the level of the on-off signal ONBH becomes the H level, the p-channel MOSFET Q41, being made turned-off, makes both of the p-channel MOSFETs Q43 and Q53 in the next stage turned-on due to the pull-down effect of the bias circuit B41. This brings the levels of the divided output voltages of the voltage dividing circuits T41 and T51 connected to the p-channel MOSFETs Q43 and Q53 to the H level to turn-on both of the n-channel MOSFETs Q46 and Q56, respectively. At this time, the charge-pumping circuit 41 is stopped while being controlled by a circuit not shown. However, in each of the switching devices Q1 and Q2 shown in FIG. 1, the gate terminals of which are connected to the terminal having the output signal GS is outputted therefrom, the gate capacitance existing between the gate terminal and the source terminal is made immediately discharged through the n-channel MOSFETs Q46 and Q56 being turned-on and the resistor R51 to lower the gate voltages of the switching devices Q1 and Q2. This results in the off-driving of the switching devices Q1 and Q2, which brings the level of the voltage at the OUT terminal 9 to the L level. In the short circuit detection circuit 14a at this time, although the state is not in a load short circuit, the voltage at the OUT terminal 9 is to be inputted with the level thereof being brought to the L level. This turns-on the p-channel MOSFET Q32 to bring the level of the input voltage of the inverter circuit 31 to the H level, by which the level of the signal SCB outputted from the inverter circuit 31 is made to be the L level. The signal SCB, the level thereof being the L level, turns-on the p-channel MOSFET Q63, by which the clamping circuit 42 is also in the clamping operation as was explained in the foregoing.

Here, the operation when the short circuit detection circuit 14a shown in FIG. 4 is substituted by the short circuit detection circuit 14 according to the invention shown in FIG. 5 will be explained. In FIG. 6, a comparison between the outputting operation waveform of the short circuit detection circuit 14a and the outputting operation waveform of the short circuit detection circuit 14 is shown together with the inputting operation waveform.

The short circuit detection circuit 14 has a configuration in which a resistor R32 (resistance value R) is connected in series to the output side of the short circuit detection circuit 14a and a capacitor C31 (capacitance value C) functioning as a kind of a speed-up capacitor is connected between the input side and the output side (between the OUT terminal 9 and an output terminal of the signal SCB). Namely, the short circuit detection circuit 14, with the capacitor C31 connected between the input side and the output side thereof, forms a circuit in which an output voltage becomes equal to the input voltage at the instant of a step-like change in the input voltage and thereafter decreases with a speed corresponding to a time constant determined by the resistance value of the resistor R32 and the capacitance value of the capacitor C31. Therefore, letting the sum of the drain (gate)-source voltage of the p-channel MOSFET Q31 in diode connection and the threshold value of the input voltage of the p-channel MOSFET Q32 be Vth, the threshold value of the input voltage of the short circuit detection circuit 14 expressed as VCC−Vth is determined as being equal to the threshold value of the input voltage of the short circuit detection circuit 14a. Here, for obtaining a desired threshold value of the input voltage, the p-channel MOSFET Q31 in diode connection can be substituted by another device such as a diode or a resistor.

Here, at the on-driving timing at which the level of the voltage at the OUT terminal 9 is the H level, the p-channel MOSFET Q32 is made to be turned-off. Thus, by the bias circuit B31 for pulling-down the voltage of the drain terminal of the p-channel MOSFET Q32 to a voltage at the L level when the p-channel MOSFET Q41 is turned off, the level of the input voltage to the inverter circuit 31 at the next stage becomes the L level and the level of the output voltage thereof becomes the H level. The output voltage of the inverter circuit 31 at the H level is given to the output terminal of the signal SCB through the resistor R32, by which the level of the signal SCB becomes the H level.

While, at the off-driving timing at which the level of the voltage at the OUT terminal 9 is the L level, the p-channel MOSFET Q32 is made to be turned-on. Here, the p-channel MOSFET Q32 is protected by the resistor R31 and the diode D31 with the voltage at the gate terminal thereof limited to be lower than the gate breakdown voltage thereof, by which the threshold value of the input voltage of the p-channel MOSFET Q32 is established within the range of the limited voltage from the power supply voltage VCC. AT this time, a voltage at the H level is inputted to the inverter circuit 31 to make the output voltage thereof at the L level. This causes the voltage of the signal SCB to be equivalently pulled-down to the L level by the resistor R32. In this way, the p-channel MOSFET Q32 and the inverter circuit 31 form a logic element which outputs a non-inverted signal of an input signal.

In this state, the initiation of the next turning-on in a normal switching operation initiates the rising in the voltage at the OUT terminal 9. Letting the voltage across the terminals of the capacitor C31 (capacitance C) be Vc, a transient current as a charging and discharging current of the capacitor C31 with the value thereof expressed as C·dVc/dt flows from the OUT terminal 9 to the output terminal of the signal SCB through the capacitor C31. The transient current further flows through the path of the resistor R32 (resistance R) and the output terminal of the inverter circuit 31 to the internal GND (because the voltage at the OUT terminal 9 at this time is still less than the threshold value of the input voltage to the short circuit detection circuit 14 to cause the output voltage of the inverter circuit 31 to be still at the L level).

Letting the output impedance of the inverter circuit 31 be negligibly small, the voltage appears at the SCB terminal in the transient state follows the waveform of the rising voltage at the OUT terminal 9 to become a voltage having a rising waveform with the magnitude thereof expressed as R·C·dVc/dt. As will be explained later in detail, the voltage of the SCB signal based on the current charging and discharging the capacitor C31 rises to reach the threshold value of the input voltage to the p-channel MOSFET Q63 in the clamping circuit 42 earlier than the output voltage of the inverter circuit 31. This means that the clamp releasing operation of the clamping circuit 42 is initiated earlier than in the case without the capacitance C31 and the resistor R32.

Next to this, a comparison will be made between the operation of the short circuit detection circuit 14 and the operation of the related short circuit detection circuit 14a with reference to FIG. 6. In the short circuit detection circuit 14a, at the time when the increasing voltage at the OUT terminal 9 reaches the threshold value VCC−Vth of the input voltage to the related short circuit detection circuit 14a formed of the resistor R31, the diode D31, the p-channel MOSFETs Q31 and Q32, the bias circuit B31 and the inverter circuit 31, the voltage of the signal SCB initiates rising from zero (the electric potential of the internal GND). At the time when the voltage of the risen signal SCB reaches the threshold value of the input voltage to the clamping circuit 42, the clamping operation is released. This causes a time delay from the time at which the voltage at the OUT terminal 9 initiates an increase to the time at which the voltage at the OUT terminal 9 reaches the threshold value of the input voltage to the related short circuit detection circuit 14a before making the clamping circuit 42 release the clamping operation.

Compared with this, in the short circuit detection circuit 14, the voltage of the signal SCB increases with an increase in the voltage at the OUT terminal 9. Thus, when the voltage at the OUT terminal 9 reaches the threshold value of the input voltage to the short circuit detection circuit 14, the value of the voltage of the signal SCB has reached the value higher than zero. In addition, since the value of the voltage of turning-off the p-channel MOSFET Q63 in the clamping circuit 42 for releasing the clamping operation (threshold value) is set lower than the threshold value of the input voltage to the short circuit detection circuit 14 as will be explained later, then the value of the signal SCB higher than zero is further higher than the threshold value of the clamping circuit 42 when the voltage at the OUT terminal 9 reaches the threshold value of the input voltage to the short circuit detection circuit 14. This is that the clamping circuit 42 has released the clamping operation thereof already when the voltage at the OUT terminal 9 reaches the threshold value of the input voltage to the short circuit detection circuit 14.

Here, the electric potential of the internal GND is higher than the electric potential of the GND terminal 4, i.e. the ground potential. For example, the electric potential of the internal GND is on the order of VCC −6V. Thus, letting VCC be 15V, the electric potential at the internal GND becomes 9V. In the short circuit detection circuit 14, at the beginning of an increase in the voltage at the OUT terminal 9, the foregoing voltage equivalent to R·C·dVc/dt is added to the internal GND at the electric potential higher than the ground potential. Therefore, before the voltage at the OUT terminal 9 (with the initial value thereof being at the ground potential) reaches the threshold value of the p-channel MOSFET Q32, the voltage of the signal SCB is to reach the threshold value of the input voltage of the p-channel MOSFET Q63 in the clamping circuit 42 to release the clamping operation.

The voltage of the signal SCB is also inputted to the input and output control logical circuit 17, which stops, in on-driving in a normal state, making the decision of overcurrent detection and outputs the on-off signal ONBH at the L level as is shown on the left side of a timing chart at the upper-left of FIG. 4. During the on-driving, the level of the signal SCB is the H level because the voltage at the OUT terminal 9 not shown in FIG. 4 is the H level.

When the load driving circuit 1 is brought into an overcurrent state during the on-driving, the level of the voltage at the OUT terminal 9 becomes lower. And when the level of the voltage at the OUT terminal 9 becomes lower than the threshold value of the input voltage to the short circuit detection circuit 14 or 14a, the level of the voltage of the signal SCB becomes the L level. Then, the input and output control logical circuit 17 makes the decision of the overcurrent detection with the signal SCB at the L level and the overcurrent detection signal and brings the level of the on-off signal ONBH to the H level with a subsequent change into a signal with an oscillating waveform when the signal SCB at the L level is continuously inputted over a specified length of time. This makes the output signal GS drive the switching devices Q1 and Q2 also with a similar oscillating waveform.

While, by the signal SCB at the L level, the clamping circuit 42 clamps the output signal GS, with which the switching devices Q1 and Q2 are driven to make the voltage at the OUT terminal 9 outputted and inputted to the short circuit detection circuit 14 or 14a as a voltage with an oscillating waveform with the peak value which depends on impedance of the load 7 and current from the switching device Q1.

When the load driving circuit 1 is recovered from the overcurrent state, the voltage at the OUT terminal 9 rises from 0V with the value thereof exceeding the threshold value of the short circuit detection circuit 14 or 14a. At this time, when the signal SCB rises from 0V simultaneously with the rising of the voltage at the OUT terminal 9 with the value thereof exceeding the threshold value of the clamping circuit 42, no oscillating waveform is exhibited in the voltage at the OUT terminal 9. However, in the related short circuit detection circuit 14a, as was explained before, the delay in the rising to the H level in the voltage of the signal SCB to the voltage at the OUT terminal 9, which has become a non-zero voltage already, causes an oscillating waveform to be still exhibited in the voltage at the OUT terminal 9, although the load driving circuit 1 has been recovered from the overcurrent state. The time in which the oscillating waveform is exhibited becomes longer by the time of the delay.

In the related short circuit detection circuit 14a, no capacitor C31 and no resistor R31 are provided. This is equivalent to the case at the limit, at which the time constant CR based on the capacitance value C and the resistance value R of the capacitor C31 and the resistor R31, respectively, is reduced to become zero in the short circuit detection circuit 14 according to the invention. The waveform of the voltage of the signal SCB in the case is the waveform shown in the middle part in FIG. 6.

By comparing the waveform with the waveform of the voltage of the signal SCB of the short circuit detection circuit 14 according to the invention shown in the lower part, it is known that with an increased time constant CR, the voltage of the signal SCB varies by following the variation in the voltage at the OUT terminal 9 to shorten the time length during which the voltage of the signal SCB is regarded as zero though the voltage at the OUT terminal 9 is not zero.

Therefore, even in such a case that the voltage at the OUT terminal 9 is affected by conditions such as the power supply voltage or a temperature to decrease the rising speed thereof to cause a delay in reaching the threshold value VCC−Vth of the input voltage to the short circuit detection circuit 14, the voltage of the signal SCB, having risen simultaneously with the rising of the voltage at the OUT terminal 9, can shorten the time length from the time at which the voltage at the OUT terminal 9 reaches the threshold value VCC−Vth to the time at which the voltage of the signal SCB reaches the threshold value of the clamping circuit 42 to release the clamping operation thereof. In addition, it sometimes becomes also possible for the voltage of the signal SCB to release the clamping operation before the voltage at the OUT terminal 9 reaches the threshold value as was explained in the foregoing. Therefore, the value of the time constant CR determined by the capacitance value C of the capacitor C31 and the resistance value of the resistor R32 is made to be sufficiently large so that the voltage of the signal SCB rises before the voltage at the OUT terminal 9 shifts into the oscillation mode. Thus, the problem can be avoided in that in a normal operation of the load driving circuit 1, a state in which the rising of the signal SCB is delayed due to the delay in the detection of the rising of the voltage at the OUT terminal 9 is incorrectly detected as an overcurrent state or a short circuit state and the clamping circuit 42 is left operated with an oscillation mode unreleased.

Suppose that the load driving circuit 1 is formed on a semiconductor chip. Then, actually selectable values for the capacitance C and the resistance R become those in the range on the order of several picofarads to hundreds of picofarads and in the range on the order of tens of kilo-ohms to hundreds of kilo-ohms, respectively, for example. However, insofar as the value of a time constant CR determined by a capacitance value C and a resistance value R is a value, which enables the voltage of the signal SCB to rise within a time shorter than the delay time from the rising of the voltage at the OUT terminal to the release of the oscillation mode as is explained before when a signal at the OUT terminal at the H level is inputted to the short circuit detection circuit 14, the capacitance value C and the resistance value R are not limited to those described in the foregoing. This is similar to the case in which the capacitor C31 and the resistor R32 are formed as external parts.

Although not particularly shown in FIG. 5, such peripheral elements as a series resistor for protecting the capacitor C31 from a surge voltage at the OUT terminal 9 and protection diodes provided between the VCC terminal 3 and the output terminal of the signal SCB and between the output terminal of the signal SCB and the internal GND for suppressing the overshoot or undershoot in the voltage of the signal SCB are sometimes contained in the short circuit detection circuit 14 as required. Moreover, there are no particular requirements for the circuit system of the internal circuit of the inverter circuit 31 when the circuit configuration therein provides a satisfactory signal transmission characteristic.

As is explained in the foregoing, the load driving circuit 1 according to the embodiment of the invention can detect the rising of the output voltage at the turning-on in a normal switching operation with little delay while keeping the current limiting function at a load short circuit. Thus, the load driving circuit 1 is prevented from such a malfunction as to incorrectly detect a state with a delay in the detection of the rising of the output voltage in a normal switching operation as a load short circuit state and shift the operation mode into an oscillation mode informing an abnormal state.

While the present invention has been particularly shown and described with reference to the preferred embodiment thereof, it will be understood by those skilled in the art that the foregoing and other changes in form and details can be made therein without departing from the spirit and scope of the present invention.

This application is based on, and claims priority to, Japanese Patent Application No. 2014-121328, filed on Jun. 12, 2014. The disclosure of the priority application, in its entirety, including the drawings, claims, and the specification thereof, is incorporated herein by reference.

What is claimed is:

1. A load driving circuit driving a load with a switching device, provided between a power supply terminal connected to the positive electrode of a power supply and an output terminal connected to the load, made to carry out a switching operation, the load driving circuit comprising:
a clamping circuit which can carry out an operation of limiting an output current of the switching device; and
a short circuit detection circuit which detects a drop in the voltage at the output terminal occurring when the load is short-circuited, and outputs a control signal to the clamping circuit, the control signal being a signal for making the clamping circuit carry out the clamping operation of limiting the output current of the switching device,
the short circuit detection circuit being provided with a capacitor between the input side thereof and the output side thereof.

2. The load driving circuit as claimed in claim 1, wherein
the short circuit detection circuit is provided with a logic element outputting a non-inverted signal of an input signal to the short circuit detection circuit as an output signal of the short circuit detection circuit, increases the voltage of the non-inverted signal outputted from the logic element with an increase in the voltage of the input signal through the capacitor, and makes the voltage of the non-inverted signal reach a voltage around a specified voltage before the increasing voltage of the input signal to the short circuit detection circuit reaches the threshold voltage of the logic element.

3. The load driving circuit as claimed in claim 1, wherein
the short circuit detection circuit is further provided with a resistor on the output side thereof, the resistor being connected between the output side of the logic element and the capacitor to generate an output voltage at the connection point of the capacitor and the resistor which voltage is based on a transient current flowing in the resistor after flowing from the input side to the output side of the short circuit detection circuit through the capacitor in a transient state at the switching operation.

4. The load driving circuit as claimed in claim 3, wherein
the switching operation of the switching device is carried out so that when the control signal is continuously outputted over a specified period in the turning-on operation of the switching device, the operation mode of the switching operation is shifted to an operation mode of externally outputting an alarm signal, and
the capacitance value of the capacitor and the resistance value of the resistor in the short circuit detection circuit are determined so as to provide a time constant with which the voltage at the connection point of the capacitor and the resistor in the short circuit detection circuit reaches the specified voltage within a specified time when a signal at an H level is inputted to the short circuit detection circuit.

5. The load driving circuit as claimed in claim 3, wherein
the alarm signal is a signal informing that the operation mode of the output current of the switching device is shifted into an oscillation mode.

6. The load driving circuit as claimed in claim 2, wherein
the logic element is formed with a p-channel MOSFET provided on the input side thereof so that a load short circuit is detected on the basis of the turning-on operation of the p-channel MOSFET caused by the drop in the output voltage at the output terminal.
